(19) United States
(12) Patent Application Publication
(10) Pub. No.: US 2010/0058210 A1
(43) Pub. Date: Mar. 4, 2010

(54) Online Investing

(76) Inventor: Simon Johnson, Mentone (AU)

Correspondence Address: WINSTON & STRAWN LLP;PATENT DEPARTMENT, 1700 K STREET, N.W., WASHINGTON, DC, 20006, US

(21) Appl. No.: 12/345,602

(22) Filed: Dec. 29, 2008

Related U.S. Application Data
(60) Provisional application No. 61/010,189, filed on Jan. 7, 2008.

(30) Foreign Application Priority Data
Jan. 2, 2008 (AU) 2008900035

(51) Int. Cl. G06Q 40/00; G06F 17/30; G06F 3/048; G06Q 30/00

(52) U.S. Cl. 715/764; 707/822; 707/722; 705/36 R; 705/14.4; 707/E17.009; 707/E17.014

(57) ABSTRACT

The present invention provides amongst other things, a new and effective means for valuing, rating and investing in Internet domain names as well as processing, analyzing and displaying investment related information.

### FIELD OF THE INVENTION

The invention relates to online investing, analysis and the purchase of Internet domain names.

### BACKGROUND OF THE INVENTION

There are many individuals and organizations that have an interest in buying and selling Internet domain names. These people and entities are often referred to as domainers.

Traditionally, purchasing domain names is quite speculative. Some domainers purchase domains that have dictionary words, while others target specific niche areas.

Domainers have traditionally used a variety of methods in order to find out which domain names are soon to become available. These have for example included:
Websites that display lists of domains and search engine links.
Computer software products that run on an end user computer.
Lists of domain names available from backordering companies

There are many problems and limitations to these traditional methods. For example, none of these provide information or analysis which might help in optimizing investments in domain names or reducing risks therein.

While there are number of web sites that provide lists of domain names and how many links they once had in a search engine, the information is limited, often inaccurate, incomplete and outdated. As such, by the time a domainer finds a name, the opportunity to backorder it has usually passed.

US Patent Application Publication: US 2006/0161683 A1 (King et al) describes a process of saving a domain name in a database for the purposes of a domain name auction.

US Patent Application Publication: US 2002/0129013 A1 (Thomas) describes domain name registrations. The patent provides examples of monitoring for use by trademark owners and competitors.

U.S. Pat. No. 6,745,248 B1 (Gardos et al) is limited to analyzing root zone files by performing a string search in the “downloaded root zone file” itself. This is a very ineffective and antiquated method of attempting to find the name of a particular entity. One of the main disadvantages of the method disclosed in this patent is the fact that the entity responsible for the domain, may not use its name in data found in the zonefile.

Current methods of using an end users computers to run computer software is severely limited. It can also be cumbersome, costly and may result in a variety of security issues. For example, many software programs need an end user to:
Download files containing lists of domain names. This is time consuming and may result in large amounts of bandwidth being consumed. Depending on the end user's Internet plan, it may also be costly as these files can be very large. If the end user wanted the latest information, they would need to do this each day.
The software then uses an end user's Internet connection to query a search engine. This can lead to an end user's IP address being blocked by search engines for excessive number of queries. As such, after running a software program, the end user may not be able to use their favorite search engine.
Some programs use proxy servers to hide the end user IP address, and thus avoid being blocked. An end user may not have access to large numbers of proxy servers. While there are lists for sale, the end user may need to seek permission from the owner, otherwise they could be breaking the law.
Dedicate their computer exclusively to checking domains. Such software products can be very resource intensive and can consume large amounts of CPU and memory. As such, the end user may not be able to use the computer for anything else.

As a consequence, computer programs that run on a home PC can be unworkable.

Lists of domain names are available from backordering companies, however these lists are severely limited as they only contain the domain name, date and/or default bid price, which is usually in the range of $59 to $79 depending on the backordering company. There is no other information which would be helpful to making investment decisions about domain names.

Another problem with backordering company lists is that they are often incomplete. One backordering company may receive domain names exclusively from a specific registrar. As such, a domainer may download a list from one backordering company that excludes domain names from other registrars—and is therefore incomplete. Consequently the domainer would be missing out on domain names that are available elsewhere.

### SUMMARY OF THE INVENTION

The present invention provides amongst other things, a new and effective means for valuing, rating and investing in Internet domain names as well as processing, analyzing and displaying investment related information. In one aspect, it provides a complete list of expiring, expired and/or domain names for sale either at a fixed price and/or auction, and additional information and attributes relating to monetization and scoring and/or rating of those domain names. Furthermore, the present invention may be used from any Internet connected device that can browse the web; it can send an end user updates via a variety of communication means, such as for example instant message and/or SMS and enables end users to be kept up to date with the domains of interest, with little to no overhead expense.

The actual dollar value of an Internet domain name is dependent on what the market will pay. Consequently, the inventor has found that it is better to score or rate a domain name based on one or a plurality of factors, as per the current invention.

According to one aspect of the invention, there is provided a method of analyzing one or more characteristics of a domain name comprising
a. collecting data associated with a domain name;
b. storing the data; and
c. analyzing the data according to one or more predetermined criteria to produce a domain name analysis.

The method of the invention may be used to inform a suitable decision, for example, an investment decision, and/or a domain name management decision. Further useful steps may of course also be added to the invention, for example, the step of optionally communicating, and/or storing the domain name analysis in a human-readable form. Communication of the domain name analysis may be done by any suitable means, for example display on a screen and/or communication via a mobile device.

A domain name management decision informed by an analysis of the present invention may comprise any suitable decision for example, it may comprise one or more of an advertising decision, traffic management, domain parking, and search engine optimization.

Data may be collected from any suitable source, including various publicly available databases, etc. Data may be stored in any convenient or suitable manner. For example, it may be stored on a computer, server, disk, or the like. Data may be at least partially collected as a result of a search parameter determined by a user.

Analysis of the data may be done in any suitable manner, for example according to predetermined criteria, algorithms etc. The results of the analysis are extremely useful. They may, for example, be used to inform an investment decision in relation to the domain name or to value it for some other purpose, such as a licensing or other transaction.

The method may comprise one or more further steps, for example:
Searching and displaying current and historical information relating to a plurality of domain names.
Providing one of a plurality of scores, values, ratings or recommendations based on a plurality of formulas.
Providing content with predetermined characteristics in response to interaction between the domain name and 3^{rd} parties.

In some embodiments, the data and/or analysis conveys information or confers one of more benefits to the user.

In a second aspect of the invention, there is provided, a system for conducting domain name analysis comprising:
a. a user interface;
b. a processor configured to enable interactive use of the system via the user interface;
c. a processor configured to maintain and process domain name information; and
d. a storage means to store data associated with a domain name.

In some embodiments, the system is configured to enable investment analysis and reporting. In some embodiments, data and analysis results are provided to the user in response to interaction between the user and the user interface and the content conveys information or confers one or more benefits to the user.

In a third aspect of the invention, there is provided an analyser to analyse domain name data according to the present invention. In some embodiments, the analyzer may perform one or more of the following functions: generate, store, collect, and analyse domain name information.

Domain name data or information may be any information related to a domain name. Thus, it may correspond to data such as links on a search engine, or it may be an image of the web site on the domain name, potential advertising, products and services, or any thing in which a user may interact with or obtain useful insight from the information.

Domain name data or information may be of any suitable type provided that it in some way conveys a message (whether explicit or implicit) about a characteristic of the domain name.

The analysis results and/or content may take any suitable form, and may for example be product information, helpful information (such as useful to profit from domain investment) or any other suitable information. It may be provided in any suitable format including text, audio, video or other suitable sensory input to the user.

The predetermined characteristics of the content may be set by the entity wishing to obtain a benefit (for example a domain name in specific industry). Such characteristics may be for example include the type of content to be provided, the mode of delivery, or any other suitable characteristics.

Interaction between the user and the information may take any suitable form. It may be via a computer, mobile phone or by any more direct means. The interaction may stimulate provision of information such as product information, advertising information or any other suitable information. A benefit conferred to a user may be by any suitable means, whether online, virtual or in the real world. Thus it may for example comprise real or virtual rewards points, currency, products, services, useful information or any other suitable benefit.

Any of the embodiments illustrated above and below stand independently or features may be combined to achieve preferred embodiments. Additional advantages and embodiments of the invention will also become more apparent to those of ordinary skill in the art upon review of the teachings of the present application.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIG. 1 shows a simplified diagram of the various components of one particular method of providing domain name information according to the present invention.

FIG. 2 shows a simplified diagram depicting one particular method of obtaining and analyzing domain name data/information from zone files.

FIG. 3 shows a simplified diagram of the various factors that may contribute to one or more methods of providing a formula to score, value, rate and/or recommend the trading, buying and/or selling of a domain name.

### DETAILED DESCRIPTION

In some embodiments, the invention relates to a system and method of analyzing, rating, valuing and investing in Internet domain names and related services delivered over the Internet and/or other telecommunications network. It provides analysis of information as well as content, tools and interactive services to end users to help them make profitable decisions. Purchasers of domain names can therefore use this system and method to reduce risk and increase the likelihood of profitability.

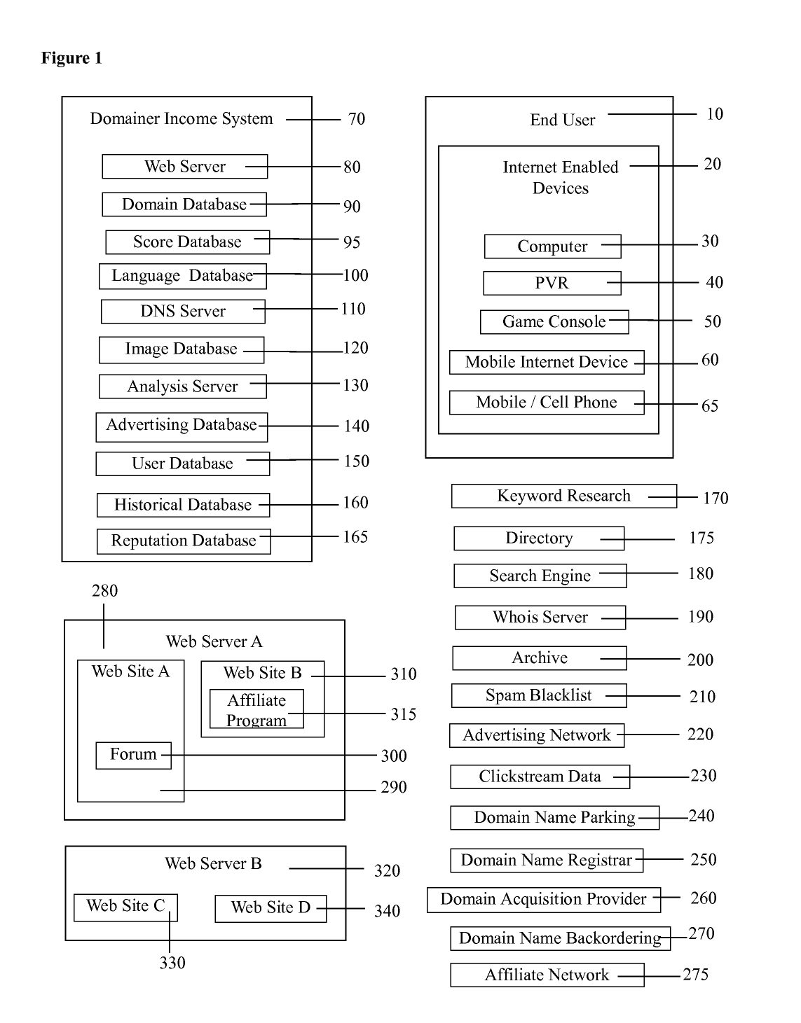

FIG. 1 shows a simplified diagram of the various components of one particular method of providing domain name information according to the present invention.

An end user 10 may use any suitable means, for example a computer 30, PVR 40, game console 50, mobile Internet device 60, cell or mobile phone 65, or any other access device 20 to access the domainer income system 70 via the Internet or other communications network. In one possible embodiment of the invention, domain name information may be displayed to the end user 10 by one or a plurality of web servers 80 which retrieves data and information stored in a domain database 90 and on other servers and/or databases in the domainer income system 70.

Depending on how the end user 10 interacts with the domainer income system 70, the system, according to the present invention may display information, attributes and/or characteristics regarding one or a plurality of domain names. Information may also be communicated to an end user 10 via a plurality of methods including for example, Internet enabled devices and telecommunications protocols such as email, SMS, MMS, Instant Messaging and VoIP. This enables an end user 10 to be kept up to date with the latest information.

For example, in one possible implementation, an end user 10 who is interested in domain names on a particular topic may receive information via a text message on their cell phone when a domain containing a specific characteristic, such as a keyword (or category), becomes available to backorder, register, listed for sale and/or auction.

In another possible implementation, an end user 10 who is interested in domain names on a particular topic or niche market, may receive an alert via a computer program on their computer or Mobile Internet Device 60. Such an alert may be based on a predefined set of criteria and/or thresholds relating to domain name investment information. Thus, for example, the end user may receive information which provides insight into the current or future value of the end user's current domain name portfolio, or one or more domain names that the domainer is considering purchasing or adding to his or her portfolio.

With regard to FIG. 1, an end user 10 may use the current invention to search based on a criterion using a domain database 90 and other parts, functions and information collected and/or obtained by a Domainer Income System according to the present invention 70 and for example third-party providers including but not limited to Domain Acquisition Providers 260, Domain Name Backordering companies 260. Such search criteria may for example include, but are not limited to the following:
Domain name related information
A registration detail
A date, such as creation, expiry, number of years registered, estimated drop and/or deletion dates
Domain name status.
Registrar details.
Personal information and/or contact details
Geographic and/or jurisdictional information.
Registry level data.
Nameserver data.
   In one possible implementation the end user 10 may search for one or a plurality of domain names that use one or a plurality of name servers.
   In another possible implementation, the end user 10 may search for one or a plurality of domain names that are parked at a particular parking company.
Information related to search engines and directories.
Information related to advertising, which may or may not be related to one or a plurality of keywords and keyphrases found in a domain name.
Information relating to potential or actual competitors. For example, this could be in the form of competitors advertising, search engine ranking, characteristics relating to a competitors domain name and website characteristics.
Information related to affiliate programs, products and services, which may or may not be related to one or a plurality of keywords and keyphrases found in a domain name.
Backlinks—such as the number of backlinks from websites and/or Internet hosted information and/or services.
The quantity and quality of information indexed by search engines.
One or a plurality of keywords and/or key phrases found in a domain name.
The number of characters in a domain name.
The presence or lack of hyphens and/or numbers in the domain name.
A language used in a domain name.
A Word or abbreviation
Domain name extensions. For example: one or a plurality of international domain names and/or TLD and ccTLD's.
A traffic indicator
Status of one or a plurality of web pages. For example, if the main index page is not found.
A quality indicator such as one with regard to the domain name and pages that link to it
Historical information
Information relating to the reputation of the domain name
Information relating to the layout of the main webpage hosted on a domain name.
Information relating to a meta tag used on one or a plurality of web pages associated with a domain name.
Information relating to domain name parking, revenue, keywords and associated statistics.
Domain name sale and/or auction information. For example, this may include information such as pricing, category, time left in the auction and revenue characteristics.
Information relating to a return on investment for one or a plurality of domain names.
Information related to domain tasting and/or kiting.

In one possible implementation, a search may be conducted in bulk. For example, if an end user 10 wanted to find out what domain names were available to register, the end user 10 could type in a keyword, category and/or import a list.

In another possible implementation, an end user 10 may search using a specific keyword and the Domainer Income System 70 may suggest alternative keyword and/or keyphrases that have a higher earnings potential. For example, an end user 10 may type “rental house vegas” and the Domainer Income System 70 may suggest “las vegas real estate, vegas real estate” which have a higher CPC (cost-per-click).

A search may also be conducted using one or a plurality of criteria and search options.

With regard to FIG. 1, an end user 10 may use the current invention to search one or a plurality of sources of information for specific attributes relating to a domain name. Such sources may include, but are not limited to the following:
Internet forums. For example, forums that list domain names for sale.
Web sites that provide domain name auctions.
Web sites that provide domain names for sale. For example, at a fixed price or a best offer.
Data sources such as RSS feeds, text files and databases.
User input. For example, a text file and/or a URL.
Domain Name Backordering 270. For example, backordering services and/or companies.
Internet resources that provide information on domain name sales prices. For example: Internet websites or data feeds.

For example, an end user 10 may use the current invention to search a plurality of Internet auction sites and forums for domain names that relate to a specific niche market, such as real estate. In this instance, the current invention may display domain names that are for sale or auction and their attributes and characteristics in the Domainer Income System 70.

In one embodiment of the invention, the Domainer Income System 70 may help facilitate an end user 10 bidding in an auction for one or a plurality of domain names.

In one embodiment, the invention may provide one or a plurality of rankings, ratings, indicators and/or scores relating to one or more characteristics, attributes and/or domain name information. Such information could be stored and retrieved from a score database 95. In one possible implementation, the rank, rating and/or score could be based on one or more formulas. For example, one or more of the following factors could be used:
The source of traffic. For example, referrals from web sites, directories and search engines.
The quantity and quality of links to the domain name. For example, the relative authority of the linking website.
   In another implementation, a domainer income system may include factors such as the number of links to a domain name across one or a plurality of search engines that are within a certain range.
   In another implementation, weighting may be applied to specific search engines and directories depending on various factors.
The quality and quantity of web sites that link to the domain name. For example, if the hypothetical domain name “spammersareevil.com” has 800 links in MSN, 250 in Yahoo and 60 in Google, then this may provide an indicator that the domain name has been misused as it may have a number of pages that are not worth indexing. While further analysis could be provided, such a Traffic Ranking Score would greatly assist time poor domainers in working out what domains are of interest and are worth further investigation.
The quality and quantity of web sites, web pages and Internet hosted content that has currently or previously been displayed using the domain name.
Information related to web pages and/or Internet hosted content. In one possible example, the invention may determine if a web page that has been indexed by a search engine, is still accessible and contains the backlink to the domain name.
The type and sources of traffic that are coming to the referrer of the traffic. For example, website D is being analyzed. Website A and website B might link to website C. Website C then links to website D. In this instance, website A and B are the sources of traffic.
The characteristics of the sources of traffic. For example: reputation.
Whether the source of the traffic is a proxy, or has been known to operate a proxy.
A recorded history of the domain name. For example, information such as that found at archive.org
Third party traffic monitoring systems
Third party keyword and/or phrase search statistics and services.
Keywords, phrases and/or advertising data from advertisers, advertising networks and/or affiliate programs. This may include information relating to pricing including estimates, indicators and/or actual figures.
Advertising network payouts e.g.: CPM (cost per thousand impressions), CPC (cost per click), CPD (cost per day), CPA (cost per action).
Advertising statistics and trends
Keyword search trends
The types of products and services that can be advertised and/or sold on the domain name.
Keyword and/or phrase search statistics provided or cached by a database.
Domain name categories and/or classifications.
Whois data
Registry level data
Domain name registration information
Keywords found in the domain name. For example, dictionary words.
If the domain name includes one or more hyphens.
If the domain name includes one or more numbers.
Information found on the website that was previous hosted on the domain name. For example, this may include content and/or links.
The type of language used in a domain name.
The domain extension. For example, a ccTLD or TLD.
Market data such as sales, rental and auction prices. For example, domains selling at auction in a particular niche and/or domain names posted for sale on a forum.
The IP address of the main website hosted on the domain.
Attributes associated with other websites and/or domains hosted on the same IP address and/or IP address range.
Information relating to monetization of the domain name. This could enable the end user to quickly and easily determine the financial viability of a domain name.
The context of a domain name as it relates to actual and/or abbreviated geographic place names. For example, this could enable the end user 10 to analyze the effect a particular market based on the population of a city. For example, newyorkrealestate.com or nyrealestate.com.
The quantity and/or volume of traffic. This could enable the end user to quickly and easily determine how much to buy or sell a domain name for.
Seasonal trends and/or changes that lead to periodic fluctuations in characteristics. For example: holidays, occasions, weather, time of year.

In another possible implementation, the rank, rating and/or score relating to one or a plurality of end users 10 domain names could be used as a characteristic in itself. For example, if an end user 10 specialized in purchasing domain names in a specific niche, then the Domainer Income System 70 may analyze the rank, rating and/or score of the domain names that belong to that niche. This may contribute to and/or enable the Domainer Income System 70 to make a recommendation on the monetary value of the domain name and/or the end users 10 portfolio itself. In practical terms this may give guidance to an end user 10 when attempting to acquire, sell and/or value that domain name and/or their portfolio. Such a recommendation could be based on one or a plurality of formulas that apply to one or a plurality of domain names and may factor in information including:
How much traffic the domain may and/or is known to receive.
Information from one or a plurality of advertising companies. For example, cost per click for specific keywords and keyphrases.
Information from one or a plurality of parking companies. For example, number of clicks, click rate, cost per click and revenue.
The cost associated with acquiring another domain name to replace a domain name if it was sold.

In this example, a formula to calculate the daily revenue from a domain name may for example correspond to the following:

Revenue=((Views*% Click Rate)*Revenue Per Click)

### Where:

Revenue is the total amount of money received by the end user 10.
Views are the average daily number of visitors to the domain name.
Click rate is the average daily percentage of users who click on an advertisement.
Revenue per click is the average daily revenue provided to the end user. In one possible implementation, this could be from a parking company. The revenue per click may also depend on the keyword and/or keyphrase used, market trends, contracts, commissions as well as seasonal adjustments.

In one possible embodiment of the current invention, the monetary value of an end users domain name portfolio may be calculated using the above formula. In this instance, the formula may need to factor in one or a plurality of characteristics including:
An appropriate measure of time. For example, an end user 10 may value their portfolio based on 12 months potential and/or actual earnings.
Source and quality of traffic to the domain name, such as links from existing web sites. For example, traffic to a domain name could be affected when links are removed from web sites that link to that domain name.

The above formula may also be applied to information such as raw data from a parking company, and/or a Domain Name Parking 240 and/or Advertising Network 220 in order for the Domainer Income System 70 to provide information to the end user 10. For example, the Domainer Income System 70 may analyze information from a Domain Name Parking 240 company and determine that one particular parking company and/or keyword and/or keyphrase earns more revenue for a specific domain name. In this example, the Domainer Income System 70 could recommend to the end user 10 to change keywords, keyphrases, page layouts and/or parking companies. In one particular implementation of the current invention, this could be done by the Domainer Income System 70 integrating directly with a Domain Name Registrar 250 to make that change on behalf of an end user 10.

In another possible embodiment of the invention, a score in the form of letters and/or numbers could be converted into a graphical indicator. For example, one or more stars or ticks.

In another possible embodiment, the rating, ranking and/or score or the calculation method for such score could be defined by the end user 10.

FIG. 1 shows a language database 100 which may store, cache and retrieve items in a plurality of languages. These may include any suitable items, for example they may include: words, names, abbreviations, acronyms, jargon, music lyrics, movie characters, trends, popular terms, place names, plant names, phrases and misspellings. It can be queried according to the present invention, to identify information that is relevant to the domain name. For example, a domain name may be written in a particular language and have one or more keywords in the domain name. In one implementation of the present invention, the system could identify parts of the domain that correspond to cities, countries, places of interest etc. Such information could then be used to form part of an equation to score, rank, determine the value of a domain name and/or display such information to the end user.

The language database 100 may according to the present invention, be used to classify and/or categorize domain names. One possible implementation of the invention is to group domain names together in categories and/or subcategories based on one or a plurality of keywords found in the domain name. For example: the domain name “refinance-my-mortgage.org” might be categorized according to the present invention, in a main category called “Finance” and a subcategory called “mortgage”. The system may also display advertising related to the keyword mortgage along with the actual or estimated advertising payout. This may be represented in a dollar figure or in a graphical form. For example the following keywords may have the following cost-per-click:

| | |
|---|---|
| mortgage refinance rates | $40.23 |
| mortgages for bad credit | $38.75 |
| mortgage loans | $35.41 |
| mortgage rates best | $35.26 |

A DNS server 110 may provide IP address details. In one possible implementation, the current invention may use the IP address details to provide geographic related information regarding the domain name and domain name related information.

In another possible implementation, the Domainer Income System 70 may facilitate the provision and ongoing management of the investment. In one possible example, if a buyer acquires a number of domain names for the purpose of diverting traffic from these domains to a specific destination such as a website; the Domainer Income System 70 may act in the capacity of a registrar and provide domain name registration and DNS management for these domain names. In this instance, one or a plurality of DNS servers 110 may be used.

In another implementation, the Domainer Income System 70 may enable the end user to divert traffic and/or change their DNS records individually, by group, category or in bulk. For example, an end user 10 could require some of their domain names to be parked at Parking Company A, while the other names to be at Parking Company B. While the Domainer Income System 70 could act in a capacity as a registrar, it may also communicate and/or integrate with other registrars to provide this service. Consequently, the benefit to the end user 10 is that they can quickly and easily change their nameserver (DNS) details using one interface. This can avoid the time consuming process of having to login to multiple registrars to modify their DNS (nameserver) settings.

FIG. 1 also shows an image database 120 which may store, cache and retrieve a snapshot of a domain name according to the present invention. Such a snapshot could be a graphical image or images in the form of a .jpg or .gif file of the web site or sites using the domain name.

In one embodiment of the invention, an analysis server 130 may be used to store, cache, retrieve, analyze and/or process data from one or a plurality of zonefiles, domain lists, drop lists and other domain name related files and data sources, in order to derive information relating to:
New domain names
Refunded domain names (also known as tasting or kiting)
Expiring domain names
Expired domain names
Domains that are in a drop-cycle
Domains that are in the following status: registrar hold, redemption grace period (RGP), pending delete.
Domains that are in the following states: client delete, policy delete and renew prohibited.
Domains that are available to be registered and have not been previously registered.
Domains that have been previously registered, deleted and are now available to be registered.
Domains that are in a status, other than available.
Popular domain name parking companies
The use of domain names by particular entities such as people and/or companies.
A geospatial map relating to domain names and their characteristics and attributes
Domain names that are currently or could be for sale, rent or auction.
Domain names that are currently or could be provided to a specific registrar for sale, rent or auction.
Entity relationships

In one possible embodiment, the invention may classify domain names according to the above characteristics and enable an end user 10 to obtain detailed domain name information relating to one or a plurality of domain names.

In another embodiment of the invention, an analysis server 130 may be used to provide an end user 10 with information relating to trends. For example, the present invention could analyze keywords found in domain names and record how often they occur (also known as frequency). This information could be displayed in both a graphical and textual form. One possible example is to display keywords in a domain keyword cloud whereby the keywords that have a high frequency are larger than those with a lower frequency.

The analysis server may provide any suitable analysis which is of potential benefit to the end user. In some embodiments, it analyses successful investment strategies by domainers in domain names and provide guidance. For example, in one possible implementation, the invention could determine the buyers and/or end users 10 risk appetite and compare it to information on a plurality of domain names.

In another possible implementation the Domainer Income System 70 may provide competitive intelligence and/or monitor domain name investors. For example, the system may analyze Whois records, auction results and characteristics belonging to one or a plurality of domain names.

In another possible implementation recommendations could be performed in a similar way to that of financial risk associated with low, medium and long term investment strategies. For example, an end user 10 and/or buyer may have a preference to acquire domain names and/or a portfolio of either, part or all of the following:
Domains in specific niches. For example: real estate related domain names that focus on a particular geographical area.
Generic domain names.
Domain names that are known as direct navigation and/or type-in traffic.
Domain names that receive traffic from a particular geographic region.
Domain names that receive a high volume of traffic. For example, this may lead to high click through rates and if optimized correctly may yield a high rate of return.
One or more scores, values, ratings and/or formulas by the Domainer Income System 70 that may indicate a specific level of risk and return. For example, a high return and low risk.

In this example, the Domainer Income System 70 may provide domain name related data and/or information which matches the end user 10 preferences.

In another possible implementation of the current invention, the Domainer Income System 70 may display, cause to be displayed and/or recommend domain names based on emerging trends. For example, the Domainer Income System 70 may check to see if a domain name is available to be registered (and/or register it automatically on behalf of the end user 10) based on a specific keyword and/or keyphrases. This could be based on an industry trend, news or topics that are emerging. Such information could be obtained and analysed by the Domainer Income System 70 from one or a plurality of sources. For example, data feeds, breaking news feeds, user input, proxy server logs, packet sniffing, clickstream data, 3^{rd} party keyword research services and/or tools.

In another possible implementation of the invention, the analysis server 130 may collect, store and analyze information and/or data relating to one or a plurality of investment strategies. This may include data and/or information which has been:
a) Provided by the buyer. For example, if the buyer was acquiring the domain name for:
   A specific purpose such as product or service, or if the buyer saw the domain as being underdeveloped in one or a plurality of areas.
   The purposes of parking it at another parking company in order to earn more revenue.
   The purposes of adding it to an existing portfolio of domain names on specific topic or subject matter.
   The purposes of developing it into an Internet website or service. For example, some domainers may wish to develop an advertising website template as a strategy to replace parking. In this instance, the analysis server 130 may collect, store and analyze information in relation to the advertising template.
b) Provided by the seller.
   For example, information relating to an existing website, user-base, current and/or forecasted revenue and suggested alternate uses of the domain name.
c) Posted on websites and forums.
   For example, if the domain was previously posted on a forum, the BIN (buy it now) price, domain extension and the category and/or classification of the domain name.
   In another example the registered owner of the domain name may not have the time or resources to develop the domain name; in which case they may offer partnership with a third-party to develop the domain name. In this instance, information such as the revenue share, type of domain name and the market segment could be collected, stored and analyzed.
d) Obtained from databases, lists and/or data feeds.
   For example, data and/or information could be obtained from current and/or previous auctions, whether they were live (in person) or electronic. The type of auction could also be a factor in that some auctions that occur at Domain Name Conferences may have a large number of high net worth individuals bidding.
e) Obtained from electronic domain name auctions
   For example, information relating to the bidders such as their name, speed of bidding, bid prices and times of the bidding.
f) Obtained from companies, individuals and/or brokers who facilitate the process of buying, selling, auctioning and/or renting.
g) Obtained from one or a plurality of parking companies
   For example, unique visitors, revenue per click, on page optimization and keywords and/or keyphrases.
h) Obtained from statistical analysis of the content on one or a plurality of web page as it relates to users clicking on advertisements and/or content relating to products and services. For example, tracking the placement of an advertisement on a page as it relates to visitors clicking on the advertisement. This will enable the end user 10 to optimize their domain name to ensure maximum revenue. In another example, the Domainer Income System 70 may test a variety of graphics and page layouts to determine which one results in higher click through and/or conversion rates.

In another possible implementation of the invention, the analysis server 130 may collect, store and analyze information and/or data relating to one or a plurality of Domain Name Parking 240 companies and/or Advertising Networks 220. This may include data and/or information relating to:
The currency in which an end user 10 is paid. For example, a parking company operating in Europe may in Euro, while a US-based parking company may pay in US$.
The local currency of the end user 10. For example, if the user is in Australia.
The method and associated charges and commissions in which the end user 10 is paid. For example, via wire transfer, cheque or Paypal. All of these items may incur fees, depending on the financial system used.

In one possible embodiment of the invention, the Domainer Income System 70 may calculate the most profitable Domain Name Parking 240 company for a particular end user 10. Other additional characteristics that may be factored into this formula include keywords, keyphrases, products and services.

In another possible embodiment, the domainer income system 70 may display a list of domain names provide a recommendation and/or guidance in relation to a potential benefit to the end user, based on data and/or information from the Domainer Income System 70. For example, the domain names could include names that:
Have expired
Will expire
Are allocated to a specific backordering company and/or registrar
Are currently in an auction
Are about to be auctioned
Have been listed for sale

In another possible embodiment, the Domainer Income System 70 may review the end users 10 domain names that have a particular rank, rating and/or score and recommend other domain names that are similar and/or within a certain range, based on certain characteristics. For example, information stored in the analysis server 130 and/or the score database 95.

In another embodiment, the invention may facilitate the provision of domain name investment strategies. For example, such strategies could be communicated by the domainer income system 70 and/or by one or a plurality of experts and/or one or a plurality of end user's 10. In this example, detailed and/or aggregate data relating to the experts and/or end users domain name portfolio could be displayed and/or used to score and/or rank the experience of the experts and/or end user 10. This may include data and/or information from third-parties such as one or a plurality of parking companies.

If the end user 10 for example was interested in viewing information relating to domain names that have been refunded (also known as domain tasting or kiting), then a domain keyword cloud would enable them to see trends relating to specific keywords. In one embodiment of the present invention, the user could “drill down” and view a list of domain names and the associated attributes and characteristics. Such an implementation may also provide an end user 10 with a competitive advantage over other domainers, as they see what their competitors are registering.

In another embodiment of the invention, the system may identify demand patterns and demand predictability and market trends relating to domain names and domain name information using a variety of attributes and characteristics. For example, an end user 10 may view an analysis of new domain names that have been registered. In this instance, the system may predict keywords, terms and phrases that could be used to register additional domain names. Such recommendations may be cross referenced with other domain name information to provide an insight as to the monetization for one or a plurality of domain names.

Referring to FIG. 1, in another embodiment of the invention, an end user 10 may store, cache, retrieve and display advertising information from an advertising database 140. Such information may include keywords and their cost-per-click and/or other payment information and may be displayed according to the present invention based on keywords found in the Internet domain name.

According to the present invention, information relating to keyword and/or key phrase advertising and its associated monetary value may be integrated into the Domainer Income System 70 by use of an API, plug-in or other interface to obtain, display and/or reproduce such information from a 3^{rd} party. For example, a third party Advertising Network 220 or a 3^{rd} party computer program or database of information.

Another method of providing and displaying keyword and payment information according to the present invention may involve using one or a plurality of advertising networks 220 to obtain, store, link to and/or reference the information.

According to the present invention, analyzing keywords from advertisers and/or advertising networks and their monetary value, in relation to domain names may form part of the equation to rank and/or score a domain name. It may also provide an indicator for the current and future market demand and the value of a domain.

In one embodiment, the user may view specific high paying keywords related to one or a plurality of keywords, key phrases and/or a specific domain names. Such information may be displayed in a list, so that the user can obtain an accurate depiction of the types of keywords and the cost per click. In one possible implementation, the end user may view this information in conjunction with an advertiser and/or parking program. As such, the user may receive more revenue as the advertisers are paying more money to advertise on one or a plurality of domain names.

One method of displaying domain name information according to the present invention is by using an advertising database 140. An advertising database 140 may store, cache, retrieve, analyze and/or process information relating to advertising.

In one implementation, the advertising database 140 may enable or facilitate the analysis of advertising keywords and their monetary value in conjunction with attributes of a domain name.

In another possible implementation, the advertising database 140 may enable the user to use the invention to perform any or more of the following:
Search, display and/or compare a list of domain names. For example, this could be an end users portfolio or a list of domain names they are interested in.
Search, display and/or compare the advertising rates from advertising networks and/or parking companies with characteristics of the domain names. This may include keywords found in the domain name itself.
Search, display and/or compare a list of keywords with high paying, pay-per-click advertising based on one or more keywords found in the domain name.
Optimize the keywords associated with their domain names.
   For example, searchenginewarriors.com contains the phrase “search engine”. A network may pay $14.76 per click based on “search engine optimization techniques”, while it may pay $8.22 for “search engines placement”. As such, the end user can optimize their website or parking page for this specific keyword and get a higher click through rate, thus increasing revenue.
Search, display and/or compare the amount of money paid and/or a graphical indicator relating to value of one or a plurality of keywords.
Search, display and/or compare the advertising cost. For example, the cost per click, cost per lead and/or cost per action from one or a plurality of advertising networks. For example, Adsense and YPN.
Search, display and/or compare the current, cached and/or historical data relating to advertising. For example: cost per click and/or pay per click from one or a plurality of advertising networks. In one embodiment of the invention, such historical data may be compiled and stored in a local database.
Search, display and/or compare current and/or historical advertising. For example, in one possible implementation of the current invention, an end user 10 may view advertising displayed by advertising networks which relates to one or a plurality of keywords and/or key phrases.

In another possible implementation, the Advertising Database 140 may enable the user to host their domain names on a Web Server 80 within the Domainer Income System 70 and enable the end user 10 to provide a keyword and/or keyphrase on which to base advertising and content.

In another possible implementation, the Domainer Income Advertising System may suggest and/or automatically provide the highest paying keywords and/or keyphrases.

In one possible implementation of the current invention, the Advertising Database 140 may provide advertising and/or content in the form of text, audio and video to display on one or a plurality of domain names provided by an end user 10. For example, an end user 10 may earn revenue when a visitor to the website clicks on advertisement and/or purchases a product through an affiliate link.

An advertising database 140 may also provide information on affiliate programs and services according to the present invention. Matching affiliate programs, products and services, to that of domain names, may provide the end user with the ability to make a determination as to the value of the domain name. In one possible implementation of the invention, when a visitor to the domain name purchases an affiliate product, or service, the domain owner receives a commission. This could be provided via one or more affiliate programs and/or affiliate networks 275.

The domain name information may change depending on one or more characteristics of the domain name.

For example, in one embodiment of the invention, an end user 10 who has a domain name parked at a parking company 240, may search, display and/or compare keywords relating to specific pay-per-click advertising. In another example, an end user 10 who has an established website, may search, display and/or compare affiliate products and services along with their respective commissions and other benefits.

While cost per click and/or pay per click have been provided as examples, other possible implementations according to the present invention include advertising based on one or more of the following:
cost per click
cost per impression
cost per action
cost per lead
cost per sale
cost per time
cost per day
cost per multiple days
predetermined value by a 3^{rd} party
value determined by an advertising network or agency
advertising contract

In one possible implementation, the Advertising Database 140 may receive, cache, import, store and display information from a parking company. In one possible example, this may be facilitated by an end user 10 importing, uploading and/or causing data to be stored in the Advertising Database 140. This could be done manually and/or via an automated means such as a computer program, plug-in and/or via the Domainer Income System 70 itself.

In another possible implementation, one and/or a plurality of end users 10 may provide the Domainer Income System 70 with direct access to the parking company. In this implementation, the Advertising Database 140 could be used to display and compare information from a plurality of users. For example, an end user 10 may view advertising information such as click-through-revenue, across multiple parking companies based on one or a plurality of keywords and/or keyphrases. Such information may help end users 10 decide on the highest paid parking company for a particular keyword and/or keyphrase.

A user database 150 is provided according to the present invention to store and/or display user information, attributes and characteristics including but not limited to:
Personal information
Acquired domain names
New domain names from a plurality of registrars
Domain names of interest
Domain names that have, or could be backordered
Third party credentials including user id's and passwords
User ID's relating to forums, auction sites and backordering companies.
Statistics relating to new and acquired domain names.
User notes and/or comments relating to one or a plurality of domain names.
A value assigned by the end user 10 relating to one or a plurality of domain names.
Filters that display domain name information in a specific format and/or manner.
Keyword groups relating to domain names and/or categories of interest.
Information relating to the layout of the user interface. In one implementation of the current invention, the end user 10 may customize their own screen and/or interface to the invention.
Information relating to user notification systems. In one implementation of the current invention, the end user 10 may customize their own alerts relating to domain name information.

An end user 10 may also search, display and/or compare historical information relating to a plurality of domain names. Such information could be stored and/or cached by a historical database 160. It may also contain attributes and characteristics of a domain name at a given point in time. For example, the types of information stored, cached and/or displayed, according to the present invention may include:
A copy of one or a plurality of web sites hosted on the domain name.
A graphical image of one or a plurality of web sites.
A reference to a graphical image, contained in an image database 120 or in an archive 200.
Information relating to links for one or a plurality of domain names.
Information relating to a plurality of listings in search engines and directories.
Information relating to a plurality of backlinks in search engines, directories and/or Internet hosted information.
Information relating to tags, articles and/or entries on social bookmarking web sites, blogs and/or other indexes.
Information, characteristics and attributes relating to data and/or content indexed in search engines.
Information, characteristics and attributes relating to the sites that link to one or a plurality of domain names.
IP address of the web site or web sites associated with the domain.
Details associated with the Internet host that is hosting the web site
DNS server information such as name servers and host names.
Whois data
Information required to register a domain name
Meta tag information on one or a plurality of web sites hosted using the domain name
Information derived from domain sales and auctions.
   This may include information relating to pricing, bidding and user data. For example, one implementation of the invention may be to cross reference such data with Internet domain names. This may provide an end user 10 with an indicator that that one or a plurality of domain names in a particular sector or market segment, may be of value. In another implementation of the invention, an analysis of such data may contribute to a formula, score or rating of one or a plurality of Internet domain names.
Information relating to domain name parking. For example detailed historical information on earnings and traffic may support the domainer in selling their domain name and/or portfolio.
Information relating to search engine optimization techniques used by one or a plurality of web sites.
Quality of information such as content found on a web site or other source, that links to one or a plurality of domain names. One possible implementation of this invention is to review content with regard to factors such as:
   Known advertising. For example, “made for advertising” websites have large numbers of advertisements, with content “blended in” to make it look legitimate.
   Content, articles or reference to article databases, directories and web sites.
   Duplicate content
   Search engines
   Directories
   Internet content that has multiple links. For example: link farms.

One possible implementation of the provision of historical domain name information, according to the present invention is by enabling an end user 10 to search, display and/or compare domain name information across a plurality of domain names. For example, an end user 10 could compare a variety of domain names on a similar topic. This may help an end user 10 to make a determination as to what names to backorder, acquire, buy and/or sell.

Another method of providing historical domain name information, according to the present invention is to identify, search, display, cache and/or compare characteristics and analyze third party information relating to one or a plurality of domain names. This may involve obtaining information via a third-party using for example:
An API.
Spider, robot or automated computer program
Accessing a database.

In one possible implementation, the invention may search, cache, display and/or analyze information relating to links and relationships between one or more Internet domain names. For example: if an end user is interested in finding out more information about Web Site A the invention could:
Provide information relating to links from Web Site B to Web Site A, then Web Site C to Web Site A.
Provide information on a variety of factors relating to Web Site B and Web Site C. This may include an analysis of the sources of their traffic, links and other characteristics. For example, if Web Site B is listed in a particular Directory or has a number of authoritative links from well known websites.
Using this information as a factor and/or part of an algorithm, ranking, rating or an indicator as to whether or not to invest or acquire the domain name.

Another method of representing information stored in a historical database 160 according to the present invention is by using a domain cloud (commonly referred to as a search cloud). This may involve identifying keywords found in the domain name and recording the frequency and/number of said terms in a database.

For example, if the historical database holds information relating to celebritydiet.com, celebritynews.com and dietright.com then the domain cloud could graphically represent the word celebrity in such a manner to emphasize it, more so than the word diet. One possible method of emphasizing the word may be the font size. In this instance celebrity would be the larger word, with diet the second largest and news and right having equal size.

One possible implementation of a domain cloud according to the current invention is to keep a historical record of keywords used in a domain name.

In another possible implementation, a domain cloud can be generated for domain names in a variety of statuses. This may provide an end user 10 with trend information relating to popular keywords and/or their monetization characteristics.

Another method of representing information displayed by using a domain cloud is using DNS information. For example, the Domainer Income System 70 may use the names of DNS servers belonging to parking companies, in order to track market share. This could be animated to show trends in market share over time.

FIG. 1 also shows a reputation database 165. According to the present invention, this database could store, cache and/or display information which could:
Assist the end user 10 in reducing risk
Enable an end user 10 to search, display, analyze and/or compare information, attributes, characteristics and indicators relating to domain name reputation.

This may include information, attributes, characteristics and indicators relating to domain name reputation include but are not limited to:
Credit card fraud
Click fraud
Phishing activity
Proxies
Botnets
Blog spam
Forum spam
Cloaking
Black hat SEO techniques
Differences in publicly available information on one or a plurality of domain names.
Differences between data stored by the invention and third-party domain name data
IP addresses of known offenders
High risk countries
Personal information
Other sources of malicious activity
Registration information

While FIG. 1 shows an end user 10, there can be a plurality of end users 10 as well as a plurality of other third-parties, information and data including but not limited to the following:
a) Keyword research company 170
   A keyword research company 170 may provide according to the present invention, information relating to one or more keywords. Such information may include the number of searches on a particular keyword over a period of time.
   One possible method of implementation is to cross reference keywords from the keyword research company 170 with keywords found in domain names. This may provide end users with a view as to how much traffic a domain may receive if it were indexed by a search engine 180 or directory 175. In this example, there are a plurality of directories 175 and search engines 180.
   In another possible implementation, one or a plurality of keywords, keyphrases and other information may be stored, cached, and displayed using a server and/or database in the Domainer Income System 70.
b) Directory 175
   The provision of domain name information may also include, reference and/or link to data from one or a plurality of directories 175.
   In another possible implementation, information relating to a directory may be stored, cached, analyzed and displayed using a server and/or database in the Domainer Income System 70.
c) Search Engine 180
   The provision of domain name information may also include, reference, and/or link to data from one or a plurality of search engines 180. In another possible implementation, information obtained from a search engine may be stored, cached, analyzed and displayed using a server and/or database in the Domainer Income System 70.
d) Whois Server 190
   The provision of domain name information may also include, reference, cache and/or link to data from one or a plurality of whois servers 190. Such information may be displayed to the end user 10. Whois data may also be stored on a dedicated whois database server operating as a part of the invention.
   In another possible implementation, information obtained from a whois server may be stored, cached, analyzed and displayed by a server and/or database in the Domainer Income System 70.
   While FIG. 1 shows a whois server 190, the present invention may also include, reference and/or link to information relating to domain name registration.
e) Archive 200
   A third party archive 200 service, system or database may be used to store, cache and display historical information relating to one or a plurality of domain names. For example, this may include web site content at a particular point in time.
   In another possible implementation, information obtained from an archive, cache and/or archival source may be stored, cached, analyzed and displayed by a server and/or database in the Domainer Income System 70.
f) Spam Blacklist 210
   Information from a plurality of spam blacklists, also known as realtime blackhole lists may be stored, cached and displayed used as an indicator in relation to risk and fraud.
   In another possible implementation, information obtained from a spam blacklist 210 could be stored, cached, analyzed and displayed by a server and/or database in the Domainer Income System 70.
g) Advertising Network 220
   Information from a plurality of advertising networks 220 may be stored, cached, analyzed and displayed according to the present invention, to provide the end user 10 with advertising information relating to the use of particular keywords and phrases. Such information may also include the cost paid by the advertiser to use those keywords and phrases.
   According to the current invention, an Advertising Network 220 may also be defined as any thing that provides advertising for domain names.
   In another possible implementation, information obtained from an advertising network 220 may be stored, cached, analyzed and displayed by a server and/or database in the Domainer Income System 70.
h) Clickstream Data Feed 230
   Information from a plurality of clickstream data providers 220 may be obtained and analysed, according to the present invention, to provide an end user 10 with information relating to traffic, visitors, demographics, monetization and keyword research.
   In another possible implementation, information obtained from a Clickstream Data Feed 230 may be stored, cached, analyzed and displayed by a server and/or database in the Domainer Income System 70.
i) Domain Name Parking 240
   One possible implementation of the invention is to enable an end user 10 to optimize domains that are parked using a domain name parking company. For example, according to the present invention, the system could display keywords that may have a high monetary value and are relevant to one or a plurality of domain names. By changing the keywords used at a parking company, the end user 10 may earn more revenue.
   Another possible implementation of the method and system is to plug-in and/or integrate with a domain name parking company. This may enable the end user 10 to automate part of the process of optimizing their domain names.
   In another possible implementation, information obtained from Domain Name Parking 240 may be stored, cached, analyzed and displayed by a server and/or database in the Domainer Income System 70.
   In another possible implementation, an end user 10 may use the Domainer Income System 70 to redirect one or a plurality of domain names to one or a plurality of destinations. For example, an end user may want to send traffic from their domain names to a 3 party. In this example, the Domainer Income System 70 would integrate with a Domain Name Registrar 250 via an API or plug-in to make the required changes at the Domain Name Registrar 250 for this to occur.
j) Domain Name Registrar 250
   According to the present invention, the system may enable the user to register the domain name if its available. One possible implementation of the invention is to use a domain name registrar 250 to perform this action. In this instance, information obtained from a Domain Name Registrar 250 may be stored, cached, analyzed and displayed by a server and/or database in the Domainer Income System 70.
   In another possible implementation, the Domainer Income System 70 may be a registrar itself and perform the registration function.
k) Domain Acquisition Provider 260
   An end user 10 according to the present invention, may search one or a plurality of ways to acquire a domain name. With regard to FIG. 1, a Domain Acquisition Provider 260 is a third-party that provides, displays and/or facilitates the use and/or provision of domain name sales, auctions and/or rentals. Specifically, a Domain Acquisition Provider 260 could provide information in the form of a website, forum, auction, list, data feed.
   In another possible implementation, the Domain Acquisition Provider 260 could be a person, company, other entity or the Domainer Income System 70 itself.
   One possible implementation of the invention is to monitor current and future domain name auctions from a plurality of Domain Acquisition Providers 260. Such information may include but is not limited to the domain name, estimated traffic, reserve price, current bid price, buy it now price, end time, number of bids, user accounts associated with bids and other historical data.
   In another possible implementation, an end user 10 may list their domain names on the Domainer Income System 70. In this instance, for example, the Domainer Income System 70 would display, search and analyze domain name information. This may include, but is not limited to the category of the domain name, price, ranking and/or score, links, registrar and expiry date.
l) Domain Name Backordering 270
   Backordering refers to the acquisition of a domain name that has already been registered. In one possible embodiment of the invention, an end user 10 may use the Domainer Income System 70 to assist in backordering a domain name. In this example, information obtained from Domain Name Backordering 270 may be stored, cached, analyzed and displayed by a server and/or database in the Domainer Income System 70.
   The backordering function could be performed using one or a plurality of backordering companies 270 or by the Domainer Income System 70 itself. If the domain name is successfully acquired, the end user could do a number of things with the domain including for example:
      Park the domain with a parking program.
      Develop a web site using the domain name.
      Sell and/or rent the domain name to a buyer
   In these instances, the service could be delivered by the Domainer Income System 70 or a third-party.
   In another embodiment of the invention, an end user 10 may receive a notification of a domain that is available for auction. The Domainer Income System 70 may bid on the domain name on behalf of the user and acquire the domain name from the Domain Acquisition Provider 260. For example, in one embodiment, the Domainer Income System 70 may:
      automatically bid up to a predefined monetary value.
      take into consideration a number of bidding strategies. For example, time left in the auction.
      Rules of the Domain Acquisition Provider 260. For example, bids in the last 5 minutes of an auction ending.
      Provide the end user 10 with a recommendation based on current and/or historical information relating to the auction participants.
      monitor the auction and re-bid again if losing the auction.
m) Affiliate Network 275
One possible implementation of the invention is to analyze information from one or a plurality of affiliate programs and/or Affiliate Networks 275 in order to provide targeted products and services to sell via domain names.
In one possible implementation of the invention, the Domainer Income System 70 may use attributes and characteristics of a domain name to query, store, display, cache and/or search affiliate networks and/or resellers, companies and vendors for products and services. Such queries may be related to keywords found in the domain name and/or other domain name information.
Another possible implementation of the invention is to analyze information relating to one or a plurality of affiliate programs, products and/or services in conjunction with keywords found in the domain name. The method and system may then, according to the present invention, use the information as a factor relating to the score, rank, determining the value and/or market demand of a domain name.
Another possible implementation of the current invention is to search on monetization characteristics associated with the product or service. For example: an end user may search on the actual and/or average earnings of a product and/or service based on one or a plurality of keywords found in, or associated with a domain name.

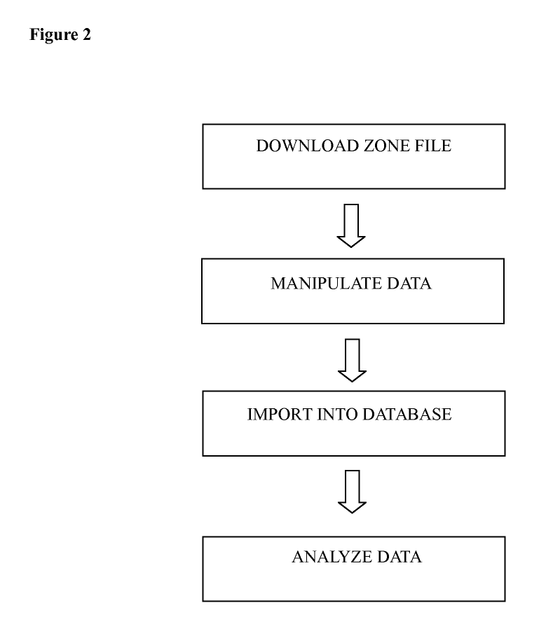

FIG. 2 shows a simplified diagram depicting one particular method of obtaining and analyzing domain name data and/information from a zone file.

One method of determining new, expired, expiring and refunded domain names, according to the present invention is to analyze data found in one or a plurality of zone files. Domain names are extracted from the zone file with the data being imported and analyzed in a database according to a set of rules, based on the current date.

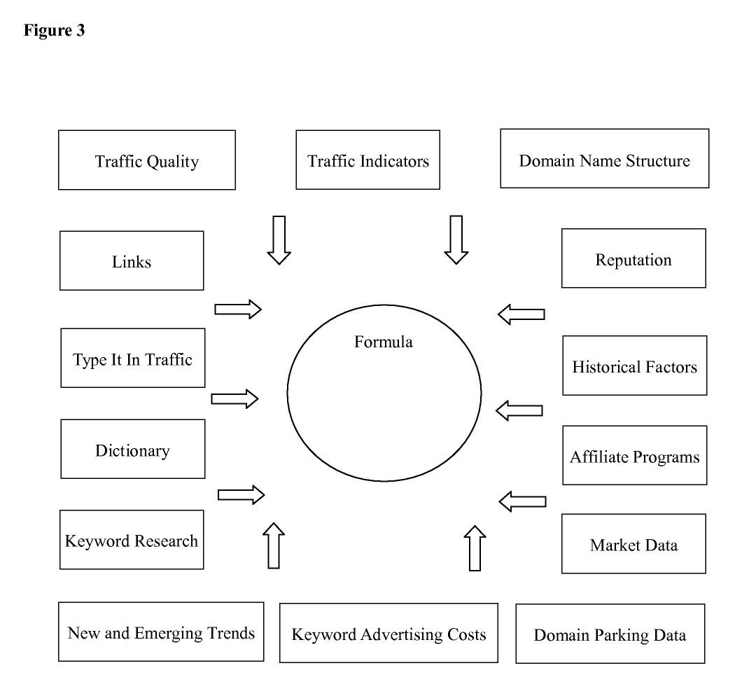

FIG. 3 shows a simplified diagram showing the various factors that may contribute to one or more methods of providing a formula to score, value, rate and/or recommend the trading, buying and/or selling of a domain name.

One method of creating a formula, according to the present invention is to consider factors from a variety of sources in order to calculate a score, value and/or rating. Such factors may include the following:
The domain name extension. For example: .com.
If the domain name is a dictionary word in one and/or a plurality of languages.
If the domain name can be spelled in a number of ways, and is therefore subject to possible confusion if you heard someone say it.
If the domain name is easily recognizable.
If the domain name is memorable.
The industry that the domain name would typically be categorized under. For example: real estate.
How relevant the domain name is to the industry.
The number of words in the domain.
How common the words are in the domain name.
If the domain contains one or more typographical errors.
If the domain contains one or more numbers.
The location and frequency of the number(s).
If the domain contains one or multiple hyphens.
The location and frequency of the hyphen(s).
The character length of the domain name.
The language used. For example: English.
The character set used.
The type of prefix used. For example: “e-” or “i-”
The type of suffix used. For example: ing.
If the domain contains joining words or phrases such as “the”, “and” or “or “allabout”.
If the domain name refers to something as singular or plural.
If the domain name does or could potentially violate trademark law.
Reputation indicators. For example: has the name previous been used to send spam?
Popularity of keywords and search terms as it relates to searches conducted on one or a plurality of search engines
Keywords, phrases and pricing from advertising networks
The number and quality of backlinks from search engines, directories and/or Internet hosted information.
The number and quality of information indexed by search engines and/or directories.
Tags and/or entries related to social bookmarking web sites and/or indexes.
Links to the domain name from other web sites and Internet content
Indicators relating to website traffic.
The relevance of the websites that link to the domain name.
The relevance or ranking of web pages that link to the domain name.
How long the domain name has been registered for.
Whois information including extended data such as registrant, administrative, billing and technical contacts.
The current and/or previous registrar(s) for that domain name
Current and previous nameserver (DNS) information.
What the domain name was previously used for.
Historical, new, emerging and/or existing trends
Affiliate products and services that are relevant to the domain name.
Information related to parking one or a plurality of domain names including but not limited to current and/or historical keywords, master keywords, phrases, categories, trends, visitors to the domain name, unique views, clicks, click through ratio (CTR), revenue per click (RPC), revenue per thousand (RPM), earnings per click, revenue, earnings, traffic analysis, referral data, search queries relating to visitors to the domain name, geographical related information, visitor origin, language related information, graphics, templates, page elements and information relating to optimization. In one possible implementation of the current invention, the information could be obtained from a parking company, end user, API or a plug-in.
Offers, counteroffers and negotiation details made and received for a domain name. For example, such information could be obtained via an auction, forum or parking company.

Another method of creating a formula, according to the present invention is to consider the above factors from a variety of sources in order to provide a recommendation as to buy, sell, hold and/or value one or a plurality of domain names. For example, in contrast to the stock market where brokers issue buy, sell, hold instructions, based on the above factors, a formula can be produced to perform this task with domain names.

Another method of creating a formula, according to the present invention is to consider the monetization aspects in order to calculate a monetary value. Such factors may include the following:
Highest paid form of advertising. For example, the highest paid converting keyword(s) and/or key phrases that cause the most number of users to click on an advertisement. In another example, the advertising could be in the form of a product, service or advertorial.
Earn out period that is acceptable to the investor.
Click through rate.
Estimated or actual number of visitors over a period of time.

For example, one possible implementation of this formula could include:

$ value=(((10%*10,000 per month)*CPC)*12 months).
Where CPC (cost per click) is the highest paid converting keyword.
12 months is the earn out period
10% is the max click through rate
10,000 is the estimated number of visitors per month

1. A method of analyzing one or more characteristics of a domain name comprising
a. collecting data associated with a domain name;
b. storing the data; and
c. analyzing the data according to one or more predetermined criteria to produce a domain name analysis.

2. A method according to claim 1 wherein the domain name analysis is used to inform an investment decision, and/or a domain name management decision.

3. A method according to claim 1 further comprising the step of optionally communicating, and/or storing the domain name analysis in a human-readable form.

4. A method according to claim 3 wherein the domain name analysis is communicated via a mobile device.

5. A method according to claim 1 wherein data is collected at least partially as a result of a search parameter determined by a user.

6. A method according to claim 2 wherein the domain name management decision comprises one or more of an advertising decision, traffic management, domain parking, and search engine optimization.

7. A system for conducting domain name analysis comprising:
a. a user interface;
b. a processor configured to enable interactive use of the system via the user interface;
c. a processor configured to maintain and process domain name information; and
d. a storage means to store data associated with a domain name.
